(19) United States
(12) Patent Application Publication
(10) Pub. No.: US 2011/0265160 A1
(43) Pub. Date: Oct. 27, 2011

(54) PASSWORD MANAGEMENT SYSTEMS AND METHODS

(75) Inventor: Timothy Andrew Nettleton, Marietta, GA (US)

(73) Assignee: Peer1 Network Enterprise, Inc., Vancouver (CA)

(21) Appl. No.: 13/120,635

(22) PCT Filed: Sep. 22, 2009
(86) PCT No.: PCT/US09/57812

§ 371 Date: Jun. 10, 2011

Related U.S. Application Data
(60) Provisional application No. 61/099,218, filed on Sep. 23, 2008.

(51) Int. Cl. G06F 15/16; G06F 17/30

(52) U.S. Cl. 726/6

(57) ABSTRACT

Password management systems include a plurality of child nodes and a mother node. Each child node includes a secure resource, a target account, and a password management service. The target account can be password-protected, and the secure resource can be accessible through the target account. The password management service can periodically update a password of the target account by requesting a new password from the mother node. In response to such requests, the mother node can generate new passwords and forward the new passwords to the appropriate child nodes. The mother node can store the new passwords in a database of current passwords. When an authorized user of the mother node requests a current password for a target account of a child node, the mother node can provide the requested current password to the authorized user. Other aspects, features, and embodiments are also claimed and described.

### CROSS-REFERENCE TO RELATED APPLICATION & PRIORITY CLAIM

This application claims a benefit, under 35 U.S.C. §119(e), of U.S. Provisional Application Ser. No. 61/099,218, filed 23 Sep. 2008, the entire contents and substance of which are hereby incorporated by reference.

### TECHNICAL FIELD

Various embodiments of the present invention relate generally to computer security and, more particularly, to password management systems and methods.

### BACKGROUND

When technical issues arrive in the operation of a computer system, remote support may be desirable. Some computer systems, however, contain secure resources and, consequently, implement security measures. The most standard of such measures is password protection. If a computer system is password-protected, however, a technical support agent will be unable to provide remote support without being authenticated to the computer system with a proper password. For increased security, some computer systems may use a dynamic password that is updated automatically from time to time. Accordingly, to provide remote support, the support agent must be made aware of updates to the password for the computing system.

In conventional systems, the support agent must contact an administrator of the computer system to request the current password. Unfortunately, this leads to inefficiencies, as an administrator will not necessarily be available when technical support is needed. As a result, technical support is generally delayed until a support agent can contact an administrator having the current password.

### BRIEF SUMMARY OF EXEMPLARY EMBODIMENTS

Briefly described, various embodiments of the present invention generally comprise password management systems and methods. Embodiments of the password management system can enable automatic updates of dynamic passwords for computer systems, while securely retaining current passwords at a location accessible to persons authorized to use the passwords. For example, in an exemplary embodiment, a password management system can comprise a mother node and one or more child nodes, where the mother node stores the varying passwords of the child nodes.

Each child node can be password-protected by a dynamic password to protect one or more secure resources associated with the child node. A child node can execute a password management service that can communicate with the mother node. Periodically, the password management service can contact the mother node to request a new password. In response to this request, the child node can receive the new password from the mother node. The child node can store the new password locally and securely for authenticating users of the child node.

The mother node can be in communication with each of the child nodes, and can maintain at least one database of passwords associated with the child nodes. At the request of a child node, the mother node can generate a new password, and transmit the new password to the requesting child node in response to the child node's request. The mother node can also store the new password in the database. Upon request from a person authenticated by the mother node, the mother node can display the current password for a selected child node.

In operation of the password management system, a child node can periodically request a new password from the mother node. The mother node can generate the new password, store the new password, and forward the new password to the child node in response to the child node's request. Upon receipt, the child node can update a dynamic password for authenticating a user to the child node. When an authorized user, such as a support agent, needs to access the child node, the support agent can authenticate himself to the mother node. The mother node can then display the current password of the child node to the authorized user, who can then log into the child node remotely using the current password.

In some exemplary embodiments, the password management system can comprise a mother node, a first child node, and a second child node. The mother node can include a storage device. The first and second child nodes can both be in communication with the mother node. The first child node can require authentication of a first password for access to a first secure component at the first child node. The first child node can autonomously contact the mother node to request a new first password. Similarly, the second child node can require authentication of a second password for access to a second secure component. The second child node can autonomously contact the mother node to request a new second password. The mother node can generate the new first password in response to the first child node's request, and can generate the new second password in response to the second child node's request. The mother node can store both passwords on the storage device of the mother node.

In some exemplary embodiments, the password management system can comprise a plurality of child nodes and a mother node. Each child node can comprise a secure resource, a target account, a password management service, and a computer processing unit. The target account can be password-protected, and the secure resource can be accessible through the target account. The computer processing unit can execute one or more instructions for implementing password management service to update a password of the target account. The mother node of the password management system can be in communication with each of the plurality of child nodes. The mother node can maintain a plurality of password records, each of which can be associated with the target account of a child node. The password management service of each child node can initiate contact with the mother node to request an updated password for the target account of the child node. In response to such requests, the mother node can generate new passwords and forward the new passwords to the appropriate child nodes.

In yet other exemplary embodiments, a password management method can be embodied in a computer program product as instructions executable by one or more computer processors. The password management method can comprise the following: providing a password management service in communication with the mother node, where the password management service is executed at a computing device; receiving a request from the password management service for a new password; responding to the request by transmitting the new password to the password management service; storing the new password on the storage device of the mother node; and enabling remote access to a secure component at the computing device by providing the new password upon request.

These and other objects, features, and advantages of the password management systems and methods will become more apparent upon reading the following specification in conjunction with the accompanying drawing figures.

### BRIEF DESCRIPTION OF THE FIGURES

FIG. 1 illustrates a first diagram of a password management system, according to an exemplary embodiment of the present invention.

FIG. 2 illustrates a block diagram of components of a computer system utilized in a password management system, according to an exemplary embodiment of the present invention.

FIG. 3 illustrates a second diagram of a password management system, according to an exemplary embodiment of the present invention.

FIG. 4 illustrates a block diagram of a child node of a password management system, and an environment of the child node, according to an exemplary embodiment of the present invention.

FIG. 5 illustrates a flow diagram of a method of updating a password from the perspective of a child node of a password management system, according to an exemplary embodiment of the present invention.

FIG. 6 illustrates a flow diagram of a method of updating a password from the perspective of a mother node of a password management system, according to an exemplary embodiment of the present invention.

### DETAILED DESCRIPTION

Various embodiments of the present invention are password management systems and methods. To facilitate an understanding of the principles and features of the password management systems and methods, various illustrative embodiments are described below. In particular, the invention is described in the context of being a password management system for periodically updating passwords of multiple remote servers. Embodiments of the invention, however, are not limited to this context, but can be used in many systems in which it may be beneficial to vary passwords or other data.

Components described as making up various elements and features of the password management systems and methods are intended to be illustrative and not restrictive. Many suitable components that would perform the same or similar functions as the components described herein are intended to be embraced within the scope of the invention. Such other components can include, but are not limited to, for example, components developed after development of the invention.

Referring now to the figures, wherein like reference numerals represent like parts throughout the views, embodiments of the password management systems and methods will be described in detail.

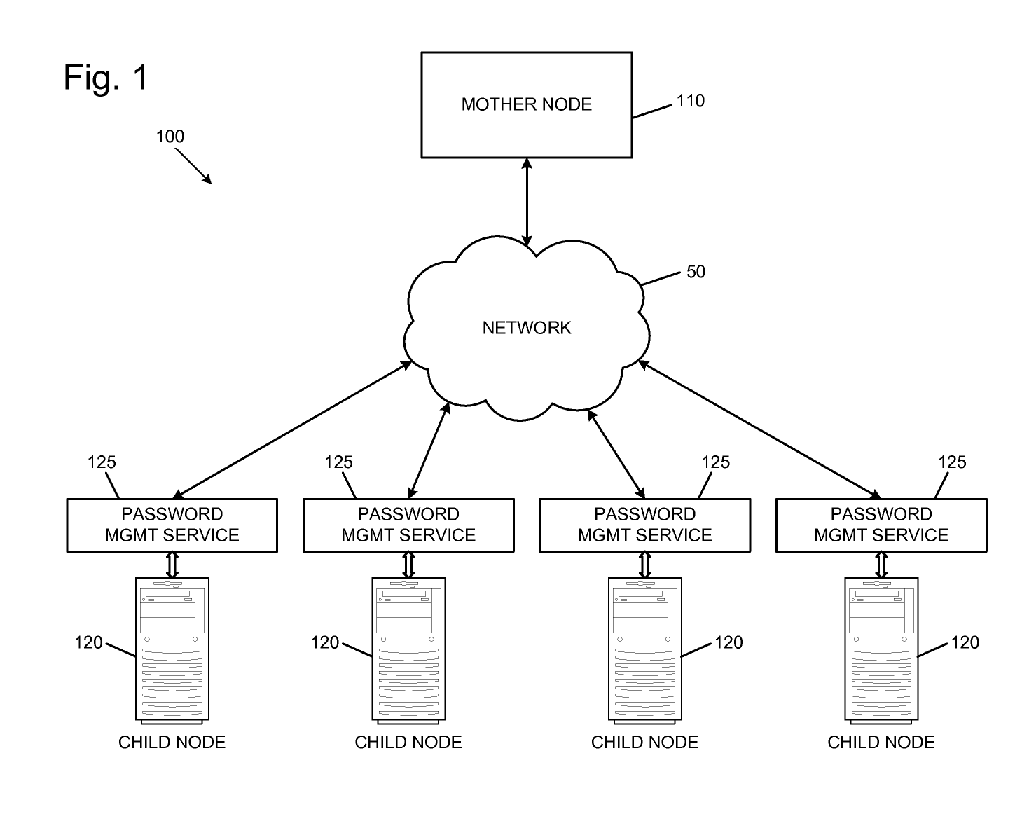

FIG. 1 illustrates a block diagram of a password management system 100 according to an exemplary embodiment of the present invention. As shown in FIG. 1, an exemplary embodiment of the password management system 100 can comprise a mother node 110 and one or more child nodes 120. The mother node 110 can be in communication with each of the child nodes 120. Such communication can exist over a network 50 or combination of networks 50, such as the Internet. In an exemplary embodiment, however, the child nodes 120 are not in direct communication with one another, although they are in communication with the mother node 110.

Each of the mother node 110 and the child nodes 120 can be a computer system. A computer system acting as a mother node 110 or child node 120 in the password management system 100 can be of various types and can have various configurations. Computer systems that may be suitable for use as a mother node 110 or child node 120 in the password management system 100 include, for example, servers, routers, personal computers, hand-held or laptop devices, multiprocessor systems, microprocessor-based systems, set top boxes, programmable consumer electronics, minicomputers, mainframe computers, distributed computers, or various other devices capable of receiving and processing computer-readable instructions.

In some exemplary embodiments, the password management system 100 can be described in a general context of computer-executable instructions, such as one or more applications or program modules, stored on a computer-readable medium and executed by a computer processing unit. Generally, program modules can include routines, programs, objects, components, or data structures that perform particular tasks or implement particular abstract data types. Embodiments of the password management system 100 can also be practiced in distributed computing environments where tasks are performed by remote processing devices that are linked through a communications network. In a distributed computing environment, program modules can be located in both local and remote computer storage media, including memory storage devices. Additionally, although some elements of the password management system 100 are described herein as being implemented in software, such elements can otherwise be implemented in hardware. Analogously, although other elements of the system 100 are described herein as being implemented in hardware, such other elements can otherwise be implemented in software.

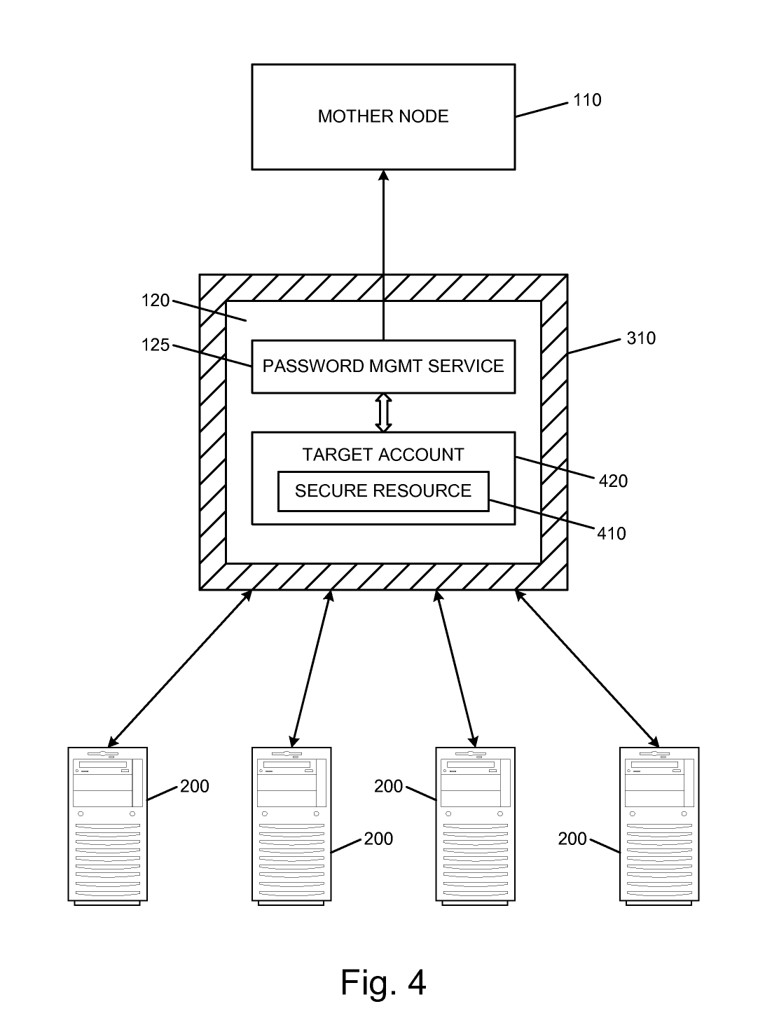

As shown in FIG. 1, the mother node 110 can be in communication with the child nodes 120. The mother node 110 can act as a server, or combination of servers, by providing one or more services to the child nodes 120. In an exemplary embodiment, the mother node 110 can be a centralized system for managing various aspects, including dynamic passwords, of the child nodes 120. Each child node 120 can be associated with a password management service 125 for updating a dynamic password of a predetermined target account 420 (FIG. 4) of the child node 120. A child node 120 can communicate with the mother node 110 through the password management service 125 to request and receive new passwords for the target account 420.

One or more of the child nodes 120 can act as servers as well. For example, a child node 120 can be a server for a website accessed by the computing devices, or can perform as a server in some other manner. For further example, a child node 120 can be a web server, an application server, a game server, a database server or many other server types. It is not necessary, however, that a child node 120 be a server. In some embodiments of the password management system 100, the child nodes 120 can comprise a mix of servers and non-server computer systems, or alternatively, the child nodes 120 can comprise all servers or all non-server computer systems.

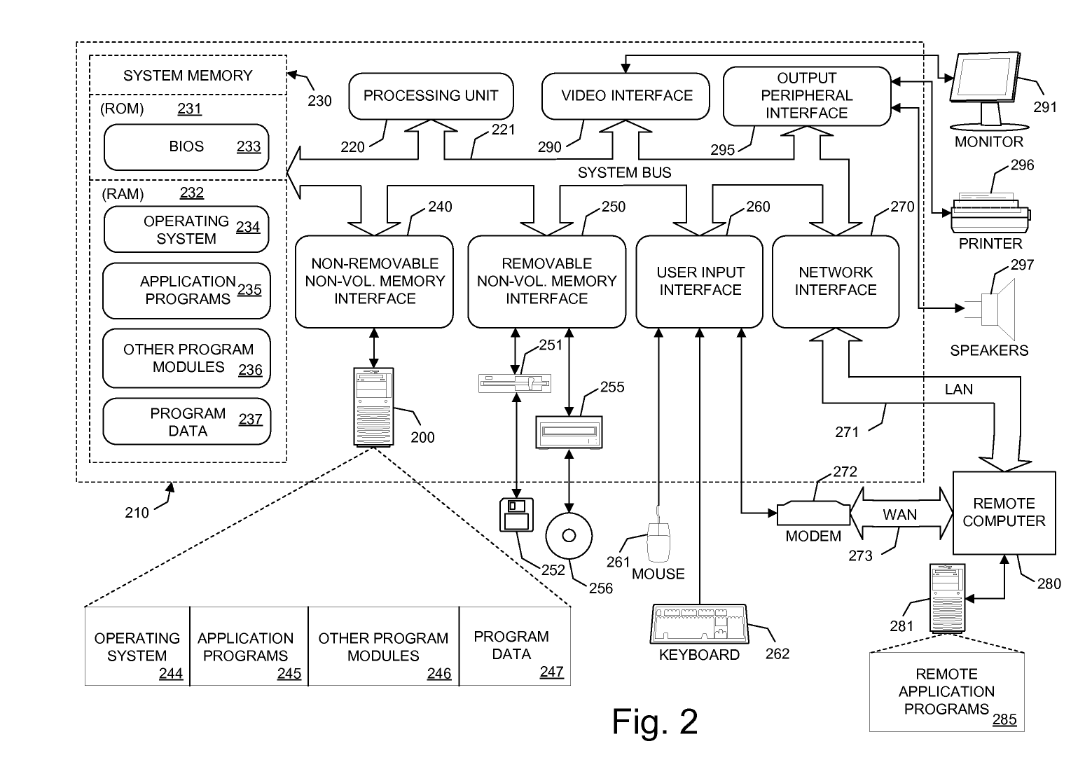

FIG. 2 illustrates a block diagram of components of a computer system 200 useable as a child node 120, a mother node 110, or a portion of a child node 120 or mother node 110 of the password management system 100. The computer system 200 and its components, as depicted in FIG. 2, represent one example of a suitable computer system 200 useable in the password management system 100, and are not intended to suggest a limitation as to the scope of use or functionality of the password management system 100. Additionally, although a single exemplary computer system 200 is depicted and described herein, the mother 110 and child nodes 120 need not all be based on a single computer system 200. In other words, the mother 110 and child nodes 120 need not comprise the same set of components, and can be different from one another in various aspects.

Components of a computer system 200 acting as a mother 110 or child node 120 can include, but are not limited to, a processing unit 220, a system memory 230, and a system bus 221. The system bus 221 can couple various system components, including the system memory 230, to the processing unit 220 for bi-directional data and/or instruction communication. The system bus 221 can be any of several types of bus structures including a memory bus or memory controller, a peripheral bus, and a local bus using any of a variety of bus architectures. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (i.e., also known as the “Mezzanine bus”).

The computer system 200 can include and interact with a variety of computer-readable media. The computer-readable media can comprise many available media that can be accessed by, read from, or written by the computer system 200, and can include volatile and nonvolatile media, as well as removable and non-removable media. For example, and not limitation, computer-readable media can include computer storage media and communication media. Computer storage media can be configured for storage of information, such as computer-readable instructions, data, data structures, program modules, programs, programming, or routines. Computer storage media can be RAM, ROM, EEPROM, flash memory or other memory technology, CD-ROM, digital versatile disks (DVD) or other optical disk storage, magnetic cassettes, magnetic tape, magneto-optical storage devices, magnetic disk storage or other magnetic storage devices, or other media that can be used to store relevant data in a manner accessible by the computer system 200. Communication media typically embodies computer-readable instructions, data, data structures, program modules, programs, programming, or routines in a modulated data signal, such as a carrier wave or other transport mechanism, and can also include information delivery media. For example, and not limitation, communication media can be a wired network, a direct-wired connection, or wireless media, such as acoustic, RF, infrared, Bluetooth, or other wireless media. Various combinations of the above are also included within the scope of computer-readable media.

In an exemplary embodiment, one or more portions of the password management system 100 and method can operate on the computer system 200, and can be stored on at least one computer-readable medium that is part of, in communication with, and/or connected to the computer system 200. In an exemplary embodiment, the password management system 100 can be developed in a programming language, for example and not limitation C, C++, Java, Assembly, COBOL.

The system memory 230 can include computer storage media in the form of volatile and/or nonvolatile memory, such as read only memory (ROM) 231 and random access memory (RAM) 232. A basic input/output system 233 (BIOS), containing the basic routines that direct the transfer of information between elements within the computer system 200 is typically stored in ROM 231. RAM 232 can store data and/or program instructions that are immediately accessible to, and/or presently being operated on, by the processing unit 220. By way of example, and not limitation, FIG. 2 illustrates an operating system 234, application programs 235, other program modules 236, and a program data 237, which can be resident in the RAM 232 in whole or in part, from time-to-time.

The computer system 200 can also include other removable/non-removable, volatile/nonvolatile computer storage media. For example, FIG. 2 illustrates a hard disk drive 241 that reads from or writes to non-removable, nonvolatile magnetic media; a magnetic disk drive 251 that reads from or writes to a removable, nonvolatile magnetic disk 252; and an optical disk drive 255 that reads from or writes to a removable, nonvolatile optical disk 256, such as a CD ROM or other optical media. Other removable/non-removable, volatile/nonvolatile computer storage media that can be included in the exemplary computer system 200 include, without, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240 Magnetic disk drive 251 and optical disk drive 255 are typically connected to the system bus 221 by a removable memory interface, such as interface 250.

The drives 241, 251, 255 and their associated computer storage media can provide storage of, for example, computer-readable instructions, data, data structures, program modules, programs, programming, or routines for the computer system 200. For further example, the hard disk drive 241 can store operating system 244, application programs 245, other program modules 246, and program data 247.

A user can enter commands and information into the computer system 200 through connected input devices, such as a keyboard 262 and pointing device 261, commonly referred to as a mouse, trackball, or touch pad. Other connected input devices (not shown) can include a microphone, joystick, game pad, satellite dish, scanner, or the like. These and other input devices are often connected to the processing unit 220 through a user input interface 260 that is coupled to the system bus 221, but can be connected by other interface and bus structures, such as a parallel port, game port, or a universal serial bus (USB). A monitor 291 or other type of display device can be also connected to the system bus 221 via an interface, such as a video card 290. In addition to the monitor 291, the computer system 200 can also include other peripheral output devices such as speakers 297 and printer 296, which can be connected through an output peripheral interface 295.

The computer system 200 can operate in a networked environment using bi-directional communication connection links to one or more remote computer systems, such as a remote computer system 280. The remote computer system 280 can be a personal computer, a laptop computer, a server computer, a router, a network PC, a peer device, or other common network node. For example, if the computer system 200 is a mother 110 node, the remote computer system 200 can be a child node 120. Analogously, if the computer system 200 is a child node 120, the remote computer system 200 280 can be a mother node 110. The remote computer can, in some cases, include some or all of the elements described above relative to the computer system 200. The bi-directional communication connection links depicted in FIG. 2 include a local area network (LAN) 271 and a wide area network (WAN) 273, but can also or alternatively include other networks.

The computer system 200 can communicatively connect to the LAN 271 through a network interface or adapter 270. The computer system 200 can connect to the WAN 273 through a modem 272 or other means for establishing a communication link over the WAN 273. The modem 272, which can be internal or external, can be connected to the system bus 221 via the user input interface 260 or other appropriate mechanism. In a networked environment, program modules depicted relative to the computer system 200, or portions thereof, can be stored in the remote memory storage device 281. For example, FIG. 2 illustrates remote application programs 285 as residing in memory storage device 281. The network connections shown are exemplary and other means of establishing a bi-directional communication link between the computers can be used.

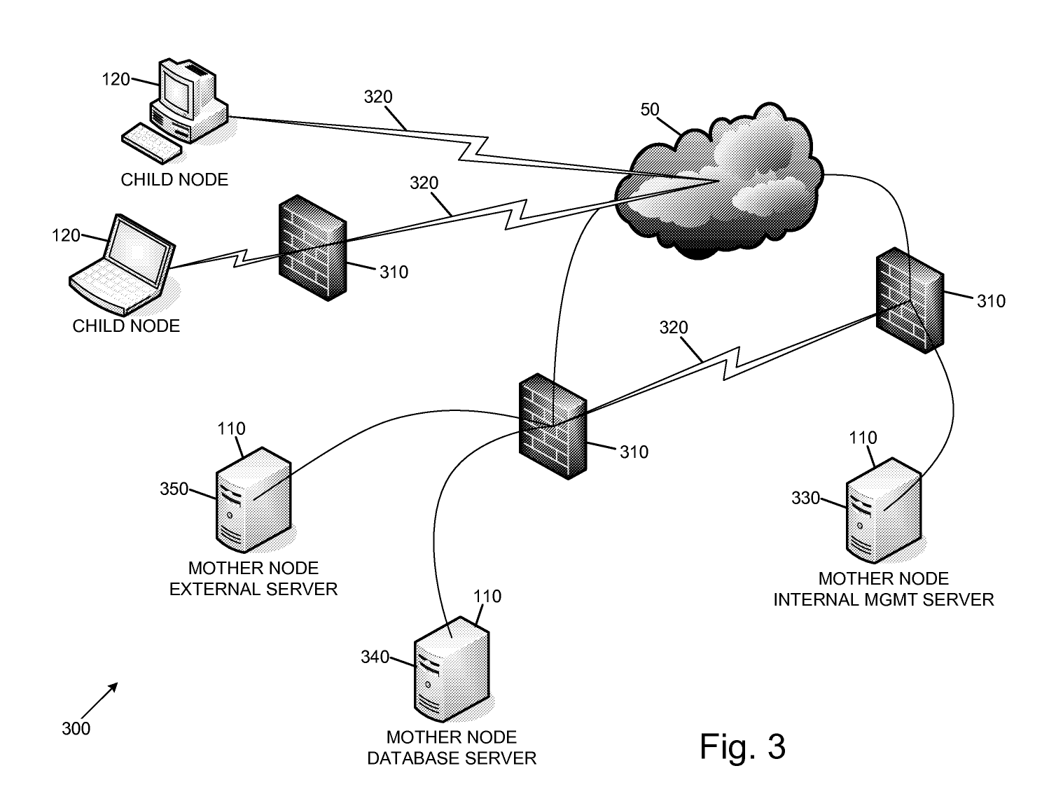

FIG. 3 illustrates a second diagram of a password management system 300, according to an exemplary embodiment of the present invention. Similar to the embodiment of the password management system 100 depicted in FIG. 1, the embodiment of FIG. 3 also includes a mother node 110 and multiple child nodes 120.

Each child node 120 can implement one or more security measures to protect at least one secure resource 410 (FIG. 4) at the child node 120. Examples of secure resources can include, without limitation, databases, administrative preferences, computer code, confidential records, sensitive files, and other data files. The security measures protecting the secure resource can include, for example, a firewall 310, as shown in FIG. 3, and a password-protected target account 420. The firewall 310 can limit access to the child node 120 and its secure resource 410 by restricting communications passing through the firewall 310. The target account can be a password-protected user account through which the secure resource can be accessible. The target account 420 can require a password to authenticate a user before the child node 120 grants access to the secure resource 410. In an exemplary embodiment of the child node 120, the password associated with the target account 420 is dynamic and, therefore, changes periodically to ensure security of the target account 420 and the secure resource 410.

In some instances, an authorized user of the child node 120, such as a technical support agent, may need to log into the target account 420 to access the child node 120 and the secure resource 410. In conventional systems, this can be problematic when the password to the target account 420 changes periodically. The password management system 100 can enable authorized users, such as a support agent, to acquire the current password to the target account 420, so as to access the secure resource 410 or other resources accessible through the target account.

The mother node 110 can provide one or more services to the child nodes 120. For example, the mother node 110 can maintain at least one database of passwords for the target accounts of the child nodes 120. Each child node 120 can be in communication with the mother node 110 over a network 50, such as through a virtual private network (“VPN”) tunnel 320. The child node 120 can transmit a request for a new password over the network 50 to the mother node 110. At the request of a child node 120, the mother node 110 can generate a new password, and can transmit the new password to the child node 120 in response to the child node's request. The mother node 110 can also store the new password in the database. Upon request from a person authenticated by the mother node 110, the mother node 110 can display the current password for the child node 120.

In some exemplary embodiments, the mother node 110 can run Windows 2000, Windows XP, Windows 2003, or Windows 2008 as an operating system, while also running IIS and Coldfusion 7 with a MSSQL Database for implementation of the password management system 100. In some other exemplary embodiments, however, the mother node 110 can run Unix, Linux, Mac OS or another, preferably scriptable, operating system. Additionally, because the mother node 110 can store passwords for the child nodes 120, the mother node 110 can implement various security features. For example, the mother node 110 can be password-protected, and can also be tightly locked down with aggressive URLSCAN settings.

As additionally shown in FIG. 3, the mother node 110 can comprise multiple physical servers, which can be load-balanced. The servers of the mother node 110 can include, for example, an internal management server 330, a database server 340, and an external server 350. Through the internal management server 330 of the mother node 110, an authorized user of the mother node 110 can perform various administrative tasks associated with the password management system 100. The database server 340 can store one or more databases utilized in the password management system 100. Through the external server 350, an authorized user can manage child nodes 120 and passwords associated with the target accounts of the child nodes 120. The internal management server 330, database server 340, and external server 350 of the mother node 110 will be described in more detail below.

As shown in FIG. 3, the various servers 330, 340, and 350 of the mother node 110 can be protected by one or more firewalls 310. The servers 330, 340, and 350 can be in communication with one another over a network, such as through a VPN tunnel 320, as needed for effective operation of the password management system 100.

The mother node 110 can conduct user sessions on its servers 330, 340, and 350 using, for example, MSSQL, LDAP, or safeword token-enabled LDAP. In an exemplary embodiment, login sessions to a server 330, 340, or 350 of the mother node 110 can occur through a secure communications protocol, such as SSL.

The internal management server 330 of the mother node 110 can provide an internal management interface for enabling interactions with the internal management server 330. Through the internal management interface, an authorized user can perform various tasks on the internal management server 330, including, for example, one or more of the following: register new child nodes 120; compile binaries for deployment of new child nodes 120; review logs of mother node 110 and child node 120 activities; schedule tasks for execution at the mother node 110 or at child nodes 120; and open RDP sessions to child nodes 120.

Through the internal management interface, or some other means, the authorized user can also retrieve a current password for a target account 420 of a selected child node 120. In an exemplary embodiment, authorized users can authenticate themselves to the mother node 110 before they are able to retrieve the current password. For example, the mother node 110 can require account credentials distinct from those required for the child nodes 120. In some exemplary embodiments, after the authorized user is authenticated and requests a password for a child node 120, the authorized user has a limited amount of time to view the password. For example, and not limitation, upon request from the authorized user, the mother node 110 can display the password for approximately 120 seconds, or some other predetermined period. This can reduce the possibility that unauthorized users near the display of the mother node 110 will see the password and gain unauthorized access to the child node 120. After the authorized user obtains the desired child node 120 password, the authorized user can connect to the selected child node by logging into the target account 420 of the selected child node 120. In an exemplary embodiment, the authorized user's connection to the child node 120 can be a remote connection through remote desktop protocol (“RDP”) or remote procedure call (“RPC”).

The internal management interface can further include one or more displays screens enabling a user to manage internal functions of the mother node 110. Through various display screens, the user can, for example: create a new install binary for establishing a new child node; view parameters for one or more binaries; modify parameters for compiled binaries; search for binaries; create tickets; and view logs for deployed binaries, password changes for the child nodes 120, compilations of binaries, user activity at the mother node 110, job scheduling and completion, failures, errors, and alerts.

The external server 350 of the mother node 110 can interface with the child nodes 120 to provide updates for the dynamic passwords of the target accounts 420. When the child nodes 120 request new passwords for their target accounts, such requests can be made to the external server 350. Additionally, one or more of the child nodes 120 can send data to the external server 350 from time to time. For example, a child node 120 can send data relating to its internal states, as well as data regarding logons and logon attempts to the target account 420 of the child node 120. Data relating to the child nodes 120 and their target accounts can be sent and received from the child nodes 120 asynchronously, through the password management services 125 running on the child nodes 120, and without prompting by the mother node 110. An authorized user of the mother node 110 can access this data to obtain information regarding functionality of the child nodes 120 and the password management system 100.

In an exemplary embodiment, the child node 120 does not require prompting from the mother node 110 to request a new password from the mother node 110. In some instances, however, the child node 120 can request a new password upon prompting from the mother node 110. For example, when a user disconnects from the target account 420, after having previously logged in with the current password to the target account 420, the mother node 110 can produce an alert or other indication that the user is now disconnected from the target account 420. In response to the alert, or after receiving some other indication of the disconnection, the child node 120 can initiate a connection with the mother node 110 to request a new password. As a result, a single password can be invalid after it has been used once to connect to the target account 420 of a child node 120.

Further, when the child node 120 detects a remote connection to its target account 420, it can attempt to validate the connection. If the connection cannot be validated, the child node 120 can terminate the connection and request a new password for the target account 420 from the mother node 110.

To initialize the password management system 100 on a computer system 200, a binary can be created by the mother node 110 and then installed on the computer system 200 to convert the computer system 200 into a child node 120. It need not be required that all computer systems 200 receiving services from the mother node 110 be configured as child nodes 120. For example, a computer system 200 that is not configured as a child node 120 can take advantage of one or more server functions of the mother node 110 without executing the password management service 125 described herein. In other words, some embodiments of the mother node 110 can provide services for one or more child nodes 120 as well as one or more other computer systems 200.

In an exemplary embodiment, the binary for each child node 120 can be customized for that child node 120. The mother node 110 can use various information about the child node 120 to create a custom binary. For example, an agent setting up a custom binary can enter into the mother node 110 the following information: identifier for an owner or customer related to the child node 120, a server identification for the child node 120, a binary name, a callback interval, and a name of the target user account. Alternatively, the mother node 110 can receive the required information by other means, such from the future child node 120 over the network 50. The mother node 110 can use the information provided to create and compile a custom binary for the child node 120.

After the binary is compiled, the binary can be stored on the mother node 110. A custom resource locator (“URL”) can be set up to provide access to the binary over, for example, hypertext transfer protocol secure (“HTTPS”). An authorized user can then remotely access the future child node 120, such as through a remote control software, and can download and run the binary from the custom URL.

While running, the binary can contact the mother node 110, for example, through an SSL connection. If the binary in unable to contact the mother node 110, the installation can be automatically terminated. If the binary successfully contacts the mother node 110, the binary continues to install a local version of the password management service 125 on the child node 120. The installed password management service 125 can have access to the unique identifier of the child node 120. The password management service 125 can contact the mother node 110 as needed independent of other local password manage services 125 running at other child nodes 120.

The database server 340 of the mother node 110 can comprise at least one storage device for storing and maintaining one or more databases of the password management system 100. The one or more databases can be used to maintain various data, such as the current passwords associated with the child nodes 120.

In an exemplary embodiment, for each child node 120 in the password management system 100, the databases can store a unique identifier and one or more encryption keys. The unique identifier can be used to identify the child node 120 corresponding to the encryption keys. In an exemplary embodiment, the encryption keys for each child node 120 are generated using the unique identifier of the child node 120 as a seed. The encryption keys can include a password encryption key and a binary encryption key. The password encryption key can be used to encrypt the password for the target account 420 of the child node 120, while the binary encryption key can be used to encrypt the installation binary corresponding to the child node 120. The encryption keys can, but need not, be RC4 encryption keys.

As discussed above, the child node 120 can be initialized by execution of a binary on the child node 120. In some troubleshooting instances, it may be desirable to re-initialize a child node 120 by recompiling and reinstalling a binary. Accordingly, the mother node 110 can store the binaries used to initialize the child nodes 120. To store the binaries securely, the mother node 110 can encrypt each binary with the binary encryption key of the corresponding child node 120. The mother node 110 can then store the encrypted binary on a storage device associated with the mother node 110. The child nodes 120 need not have access to the binaries or the binary encryption keys.

The password encryption key can be used to securely store the password to the target account 420 of the corresponding child node 120. The mother node 110 can generate a new password for a child node 120 in plain text, and can then encrypt the new plain text password using the password encryption key. The mother node 110 can store the encrypted password on one or more of the databases of the mother node 110. The password encryption key can additionally be used in communications between the mother node 110 and the child node 120. Accordingly, the child node 120 can have a copy the password encryption key as well. After the mother node 110 generates and encrypts the new password for the child node 120, the mother node 110 can transmit the encrypted new password to the child node 120.

The password encryption key can be used for other communications between the mother node 110 and the child node 120 as well. Because the child node 120 and the mother node 110 communicate over a network 50, their communications may sometimes be viewable by unauthorized parties. To reduce unauthorized access to communications, the mother node 110 can encrypt data before communicating the data to the child node 120 over the network 50. The data can be decrypted by the child node 120 upon arrival at the child node 120. Similarly, the child node 120 can encrypt data before transmitting it to the mother node 110, and the mother node 110 can decrypt the data upon receipt. To enable encrypted communications, the mother node 110 can be capable of encrypting data, such that the encrypted data is decryptable by the child node 120. Analogously, the child node 120 can be capable of encrypting data, such that the data is decryptable by the mother node 110. In an exemplary embodiment, the mother node 110 and the child node 120 can both have access to the password encryption key, which can be used to encrypt and decrypt communications between the mother node 110 and the child node 120.

If the RC4 encryption algorithm, or another symmetric encryption algorithm, is used, then the child node 120 and the mother node 110 need not store a decryption key corresponding to the above-described encryption keys. In contrast, if an asymmetric encryption algorithm is used, then the mother node 110 can additionally store a corresponding decryption key for each encryption key, and each child node 120 can additionally store a decryption key corresponding to its password encryption key.

In an exemplary embodiment, the mother node 110 can maintain at least two databases on at least one database server 350 for organizing passwords used in the password management system 100. In a further exemplary embodiment, the databases can be MSSQL 2005 workgroup databases.

The two databases can be an encryption database and a password database. For additional security, the encryption and password databases can be stored on separate database servers 340, or alternatively, the databases can both be stored on a single database server 340. In an exemplary embodiment, the password database can maintain the encrypted current passwords for the child nodes 120. In a further exemplary embodiment, the encryption database can maintain the unique identifiers of the child nodes 120 along with the password encryption keys for the child nodes 120. For each individual child node 120, the corresponding encrypted password in the password database can be linked to the corresponding unique identifier and password encryption key in the encryption database. For example, these database records can be linked in the databases through a primary key/foreign key (“PK/FK”) relationship.

FIG. 4 illustrates a block diagram of a child node 120 and its environment, according to an exemplary embodiment of the present invention. As shown in FIG. 4, the child node 120 can comprise at least one secure resource 410, a target account 420, and the password management service 125.

As illustrated, and as described previously, the child node 120 can be in communication with the mother node 110. Although, as shown in FIG. 1, the mother node 110 can be in communication with the various child nodes 120, the child nodes 120 can be isolated from one another, such that not direct communication occurs between the child nodes 120. This can be particularly desirable when the child nodes 120 are operated be unrelated entities, each of which has individual security concerns. Referring back to FIG. 4, in some embodiments, such as in some instances where the child node 120 acts as a server, the child node 120 can also be in communication with one or more other computer systems 200. The child node 120 can provide one or more services for these other computer systems 200. However, it is not required that the child node 120 act as a server or provide services for other computer systems.

The secure resource 410 of the child node 120 can be a variety of resources available on or through the child node 120. For example, and not limitation, the secure resource 410 can be confidential data stored on the child node 120 or sensitive functions operable from the child node 120.

As discussed in some detail above, each child node 120 can comprise a target account 420, through which the secure resource 410 on the child node 120 can be accessible. The target account 420 can be, for example, a technical support or administrative account. The target account 420 can be associated with a dynamic password, which can be used to log into the target account 420 locally or remotely. In an exemplary embodiment, the dynamic password can be, for example, a 20-character randomly generated password. Once logged into the target account 420 with the password, an authorized user can access the secure resource 410.

The password management service 125 can obtain a new password to update the dynamic password of the target account 420. In an exemplary embodiment, the password management service 125 obtains new passwords periodically, so as to periodically change the dynamic password for enhanced security of the target account 420. To obtain a new password, the password management service 125 can contact the mother node 110 requesting a new password. The mother node 110 can then generate the new password and transmit the new password, preferably already encrypted, to the child node 120. Upon receiving the new password, the child node 120 can update the target account 420 with the new password, such that the new password becomes the dynamic password required for authentication to the target account 420.

As further shown in FIG. 4, the child node 120 can be protected by a firewall 310. Because of the firewall 310, it may be difficult or impossible for the mother node 110 to initiate communications with the child node 120. Accordingly, to obtain a new password, the password management service 125 of the child node 120 can autonomously contact the mother node 110. The firewall 310 can allow a return communication from the mother node 110 to proceed through the firewall 310 to the child node 120. Consequently, when the mother node 110 replies to the child node 120 with a new password, the child node 120 can receive the new password through the firewall 310. Additionally, because the child node 120 can initiate contact with the mother node 120, it is unlikely that the child node 120 will end up connecting to a computer system that is imitating the mother node 110 to gain unauthorized access to the child node 120.

The password management service 125 can be autonomous in that it can request a new password without prompting from the mother node 110. Further, the password management services 125 at the various child nodes 120 can be independent of one another.

The password management service 125 can perform periodic callbacks to the mother node 110 to periodically request a new password for the target account 420. Callbacks can occur according to a predetermined formula at consistent or varying intervals. For example, in some exemplary embodiments, callbacks can be separated by a consistent interval, such as a day or an hour. In some other exemplary embodiments, the password management service 125 can perform callbacks at random intervals. In still other exemplary embodiments, the password management service 125 can perform callbacks at intervals that are randomized within a range. For example, after each callback, the password management service 125 can wait a random amount of time between two endpoints before performing the next callback. In an exemplary embodiment, each interval between callbacks can be, for example, 6 hours plus or minus 18 minutes. In other words, the callback interval can be randomly selected between five hours and forty-two minutes and six hours and eighteen minutes. For other examples, the callback intervals can be randomized to approximately one hour or approximately one day.

Callbacks to the mother node 110 for new passwords can be performed in many manners. For example, the child node 120 can access the mother node 110 through an URL to perform a callback. Each callback URL can be customized for the child node 120 and can adhere to a predefined URL format. For example, the callback URL for a child node 120 can include the unique identifier of the child node 120. The callback URL can also include a code or variable indicating the type of callback is being performed by the child node 120. The callback type can indicate the purpose for the password request (i.e., periodic password update, new child node 120 initialization, or session disconnect password update).

In response to the new password request from the password management service 125 of the child node 120, the mother node 110 can send a new password for the target account 420. The child node 120 can receive the new password from the mother node 110. The child node 120 can store the new password locally for use in authenticating users of the target account 420 of the child node 120. In an exemplary embodiment, the child node 120 can store an encrypted copy of the new password. The child node 120 can encrypt the password before storing the password, or alternatively, if the child node 120 receives the password from the mother node 110 in an already encrypted form, the child node 120 can store the encrypted password as-is.

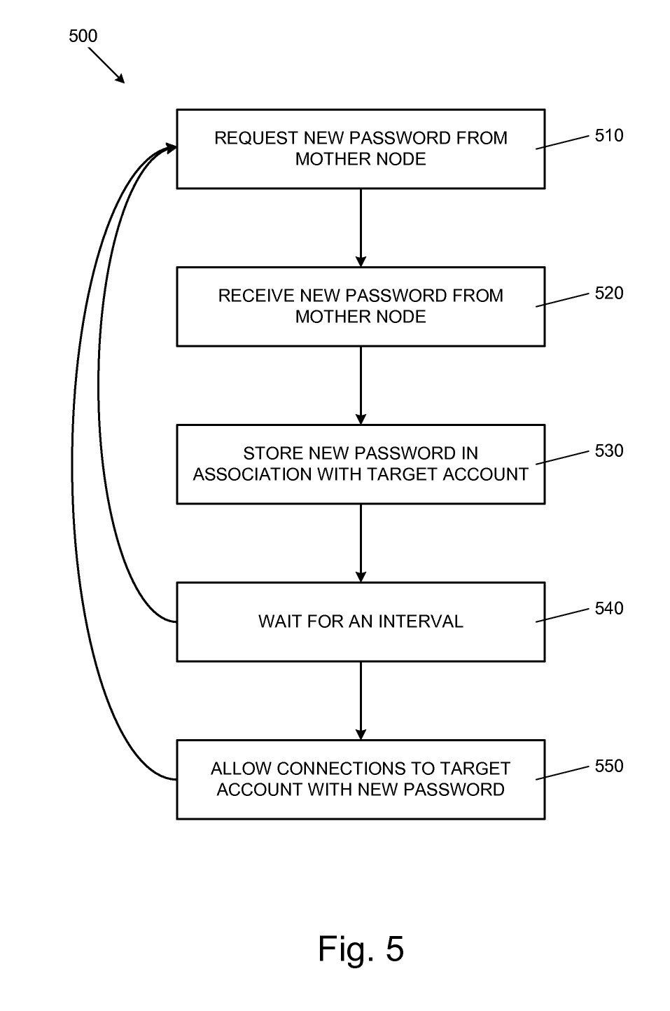

FIG. 5 illustrates a flow diagram of a method 500 of updating a password from the perspective of a child node 120, according to an exemplary embodiment of the present invention. As shown in FIG. 5, the child node 120 can request a new password from the mother node 110 at 510. At 520, the child node 120 can receive a new password from the mother node 110. At 530, the child node 120 can store the new password in association with the target account 420. The new password can be used to authenticate a user of the target account 420. In an exemplary embodiment, the child node 120 stores an encrypted version of the new password. At 540, the child node 120 waits for an interval. While waiting, at 550, the child node 120 can authenticate a user of the target account 420 with the new password. After the interval ends, or after allowing a connection to the target account 420, the child node 120 can request a new password from the mother node 110 at 510. The child node 120 can periodically perform the above tasks as long as it is desired that the target account 420 have a dynamic password.

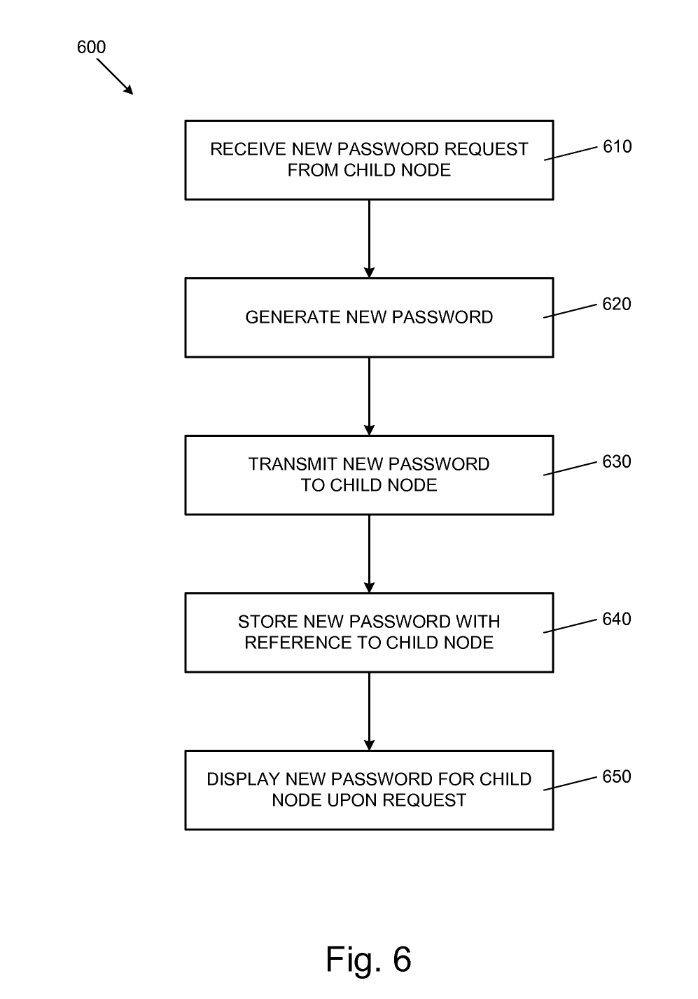

FIG. 6 illustrates a flow diagram of a method 600 of updating a password from the perspective of a mother node 110, according to an exemplary embodiment of the present invention. At 610, the mother node 110 can receive a new password request from a child node 120. The mother node 110 can generate a new password for the target account 420 of the requesting child node 120 at 620. At 630, the mother node 110 can transmit the new password to the requesting child node 120. If an authorized user of the mother node 110 requests credentials for the target account 420 of the child node 120, the mother node 110 can display the new password to the authorized user at 650.

In summary, during operation of the password management system 100, a child node 120 can periodically request a new password from the mother node 110. Upon receiving such a request, the mother node 110 can generate the new password, store the new password, and forward the new password to the child node 120 in response to the child node's request. After receiving the new password, the child node 120 can update a dynamic password of a target account 420 by setting the dynamic password equal to the new password. When an authorized user, such as a support agent needs to access the child node 120, the support agent can authenticate himself to the mother node 110 using known credentials for the mother node 110. The mother node 110 can then display the current password of the child node 120 to the authorized user, who can then log into the child node 120 remotely or locally using the current password.

Accordingly, as described above, exemplary embodiments of the password management system 100 and method can be used to manage dynamic passwords of one or more computer systems 200.

While embodiments of the password management systems 100 and methods have been disclosed in some exemplary forms, it will be apparent to those skilled in the art that many modifications, additions, and deletions can be made without departing from the spirit and scope of the password management systems 100, methods, and their equivalents, as set forth in the following claims.

1. A password management system comprising:
a mother node comprising a storage device and a computer processing unit, and being in communication with a first child node and a second child node; and
an external interface for receiving a request for a new first password from the first child node, and for receiving a request for a new second password from the second child node;
the computer processing unit of the mother node generating the new first password and the new second password; the mother node responding to the first child node's request with the new first password, and responding to the second child node's request with the new second password; and the mother node storing the new first password and the new second password on the storage device of the mother node.

2. The password management system of claim 1, the mother node providing the new first password to a user upon request.

3. The password management system of claim 1, the first child node and the second child node being located remotely from the mother node.

4. The password management system of claim 1, the first child node comprising an autonomous service for contacting the mother node to request the new first password.

5. The password management system of claim 4, the mother node deploying the autonomous service to the first child node.

6. The password management system of claim 1, the external interface periodically receiving requests from the first child node for new passwords, and the mother node responding to the first child's requests by sending the requested new passwords.

7. (Canceled)

8. The password management system of claim 1, the mother node comprising a first database for maintaining stored encrypted passwords for the child nodes, and a second database for storing decryption keys for the stored encrypted passwords.

9. The password management system of claim 8, the mother node comprising at least two servers, the first database and the second database being located on different servers of the mother node.

10. A password management system comprising:
a mother node in communication with a plurality of child nodes, each child node comprising:
a secure resource;
a target account through which the secure resource is accessible, the target account being protected by a password; and
a password management service for updating the target account;
the mother node comprising a storage device for maintaining a plurality of password records associated with the target accounts of the plurality of child nodes; and
the password management service of a first child node initiating contact with the mother node to request an updated password for the target account of the first child node.

11. (Canceled)

12. (Canceled)

13. The password management system of either of claim 10, the mother node generating a new password and transmitting the new password to the first child node in response to a request from the first child node for a new password.

14. The password management system of claim 10, the first child node having a firewall restricting communications from the mother node.

15. The password management system of claim 10, further comprising a password look-up module for presenting a password for the target account of the first child node to a user upon request of the user.

16. The password management system of claim 10, the target account of the first child node being a technical support account.

17. A computer program product embodied in a computer-readable medium, the computer program product comprising an algorithm adapted to effectuate a method for managing passwords, the method comprising:
providing a first password management service in communication with the mother node, the first password management service being executed at a first computing device;
receiving a first request from the first password management service for a new first password;
responding to the first request by transmitting the new first password to the first password management service;
storing the new first password on the storage device of the mother node; and
providing the new first password to an authorized user upon request.

18. The computer program product of claim 17, the first password management service making periodic requests for passwords from the mother node.

19. The computer program product of claim 18, the periodic requests being based on a schedule that is at least partially randomized.

20. The computer program product of claim 17, the method further comprising encrypting the new first password before transmitting the new first password to the first computing device.

21. The computer program product of claim 17, the first computing device comprising a firewall through which the mother node is unable to communicate without initiation by the first computing device.

22. (Canceled)

23. The computer program product of claim 17, the method further comprising:
providing a second password management service in communication with the mother node, the second password management service being executed at a second computing device;
receiving a second request from the second password management service for a new second password;
responding to the second request by transmitting the new second password to the second password management service;
storing the new second password on the storage device of the mother node; and
providing the new second password to an authorized user upon request.

24. The computer program product of claim 23, the first and second password management services having different schedules for requesting passwords from the mother node.
